(19) United States
(12) Patent Application Publication
(10) Pub. No.: US 2015/0037902 A1
(43) Pub. Date: Feb. 5, 2015

(54) NANOCALORIMETER DEVICE AND METHODS OF OPERATING THE SAME

(71) Applicant: Keysight Technologies, Inc., Minneapolis, MN (US)

(72) Inventors: Tirumala R. Ranganath, Palo Alto, CA (US); Carol J. Courville, San Jose, CA (US); Richard Michael Kinder, Santa Clara, CA (US)

(21) Appl. No.: 13/955,750

(22) Filed: Jul. 31, 2013

(51) Int. Cl. G01N 25/26

(52) U.S. Cl. CPC G01N 25/26
USPC 436/147; 422/51

(57) ABSTRACT

A nanocalorimeter device includes a head that defines first dispensing regions configured to receive first drops of first liquids and a cover that defines second dispensing regions corresponding to the first dispensing regions and configured to receive second drops of second liquids. The first and second dispensing regions form corresponding nanocalorimeter cells when the cover is connected to the head, each nanocalorimeter cell thereby containing first and second drops which are combined during a measurement run into a merged drop. The nanocalorimeter device further includes mini-bars pre-dispensed in the second dispensing regions, respectively, each mini-bar including a high magnetic permeability material. A magnetic driver is configured to generate a rotating magnetic field around the nanocalorimeter cells, where the rotating magnetic field causes the mini-bars to spin, mixing the first and second liquids in the merged drop within each nanocalorimeter cell.

### BACKGROUND

Nanocalorimeters generally measure heat or thermal energy released in response to chemical and/or physical reactions when fluid samples combine. The liquid samples of some nanocalorimeters may take the form of very small drops, e.g., on the scale of hundreds of nanoliters (nl), which include different materials of interest (e.g., molecules and/or proteins) and various concentrations. For example, a nanocalorimeter may include an array of cells configured to contain the drops to be merged and/or mixed together in order to determine enthalpy of a reaction at a set concentration. By combining data from a number of adjacent cells which contain drops having differing concentrations of material, thermodynamic data may be calculated. Other conventional nanocalorimeters use liquid samples in amounts larger than what can characterized as drops, the liquid samples contain a larger amount of the materials of interest. For example, the isothermal titration calorimetry (ITC) technique, which is currently the industry standard, requires use of a relatively large amount of liquid containing anywhere from about 120 micrograms (μg) to about 850 μg of protein, for example, depending on the specific instrument. Use of such a large amount of material may be expensive and wasteful, particularly when rare samples are involved.

Temperature rise or fall within each cell depends on how fast the reaction takes place, as well as any heat leakage mechanisms in operation. Therefore, heat leakage must be minimized. Further, a nanocalorimeter needs the ability to quickly mix the drops. Natural thermal diffusion, for example, has been determined to be too slow of a mixing process, and cannot be relied upon to achieve homogeneity after the merge step, particularly for large molecules and low concentrations. In general, slow mixing stretches out the time over which the thermal transient takes place, causing thermal leakages to degrade the ability to make a measurement.

### SUMMARY

In a representative embodiment, a nanocalorimeter device includes a head, a cover, multiple mini-bars and a magnetic driver. The head defines multiple first dispensing regions configured to receive first drops of first liquids from a first class of liquids, respectively. The cover defines multiple second dispensing regions corresponding to the first dispensing regions and is configured to receive second drops of second liquids from a second class of liquids, respectively. The first dispensing regions and the second dispensing regions form corresponding nanocalorimeter cells when the cover is connected to the head, each nanocalorimeter cell thereby containing a first drop and a second drop which are combined during a measurement run into a merged drop containing the corresponding first and second liquids. The mini-bars are pre-dispensed in the second dispensing regions, respectively, each mini-bar including a high magnetic permeability material. The magnetic driver is configured to generate a rotating magnetic field around the nanocalorimeter cells, where the rotating magnetic field causes the mini-bars to spin, mixing the first and second liquids in the merged drop within each nanocalorimeter cell.

In another representative embodiment, a method is provided for performing measurements using a nanocalorimeter device. The method includes providing multiple first drops of first liquids from a first class of liquids to corresponding first dispensing regions in a head of the nanocalorimeter device; providing multiple second drops of second liquids from a second class of liquids to corresponding second dispensing regions in a cover of the nanocalorimeter device; connecting the cover to the head, such that the first dispensing regions and the second dispensing regions combine to form corresponding nanocalorimeter cells, each nanocalorimeter cell containing a first drop of the first drops and a second drop of the second drops laterally offset from the first drop; and separating the cover from the head and quickly reconnecting the cover to the head in an arcing movement, causing the first and second drops within each nanocalorimeter cell to contact and coalesce into a merged drop containing the first and second liquids.

In another representative embodiment, a method is provided for performing measurements using a nanocalorimeter device. The method includes providing multiple first drops of first liquids in a first class of liquids to corresponding first dispensing regions in a head of the nanocalorimeter device, each first drop having a volume in a range of about 1 μl to about 2 μl; providing multiple second drops of second liquids in a second class of liquids to corresponding second dispensing regions in a cover of the nanocalorimeter device, each second drop having a volume in a range of about 1 μl to about 2 μl; connecting the cover to the head, such that the first dispensing regions and the second dispensing regions combine to form a corresponding nanocalorimeter cells, each nanocalorimeter cell containing a first drop of the first drops and a second drop of the second drops laterally offset from the first drop; merging the first and second drops into a merged drop comprising the first and second liquids, respectively, within each nanocalorimeter cell; and mixing the first and second liquids in the merged drop.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIGS. 1A and 1B are top plan views of a nanocalorimeter device in an open state, according to a representative embodiment.

FIGS. 2A and 2B are cross-sectional views of a portion of a nanocalorimeter device, according to a representative embodiment.

FIG. 3A is a cross-sectional view of a portion of a nanocalorimeter device in an open state, according to a representative embodiment.

FIG. 3B is a cross-sectional view of a portion of a nanocalorimeter device in a closed state before a merging operation, according to a representative embodiment.

FIG. 3C is a cross-sectional view of a portion of a nanocalorimeter device in a closed state after a merging operation, according to a representative embodiment.

FIG. 4 is a perspective view of a magnetic driver and a nanocalorimeter device, according to a representative embodiment.

FIG. 5 is a flow diagram showing a method of mixing liquids within merged drops of nanocalorimeter cells of a nanocalorimeter device, according to a representative embodiment.

FIG. 6 is a flow diagram showing a method of merging drops within nanocalorimeter cells of a nanocalorimeter device, according to a representative embodiment.

FIG. 7 is a flow diagram showing a method of performing measurements within nanocalorimeter cells of a nanocalorimeter device using large drops, according to a representative embodiment.

### DETAILED DESCRIPTION

In the following detailed description, for purposes of explanation and not limitation, illustrative embodiments disclosing specific details are set forth in order to provide a thorough understanding of embodiments according to the present teachings. However, it will be apparent to one having had the benefit of the present disclosure that other embodiments according to the present teachings that depart from the specific details disclosed herein remain within the scope of the appended claims. Moreover, descriptions of well-known devices and methods may be omitted so as not to obscure the description of the example embodiments. Such methods and devices are within the scope of the present teachings. Generally, it is understood that the drawings and the various elements depicted therein are not drawn to scale.

Representative embodiments are directed to a nanocalorimeter and methods of operating the same. Generally, calorimetric measurements are made using first drops respectively containing first liquids from a first class of liquids and second drops respectively containing second liquids from a second class of liquids, where the first and second drops contain molecules of interest. The first liquids forming the first drops may be the same or different from one another, and likewise the second liquids forming the second drops may be the same or different from one another. For example, the first liquids and/or the second liquids may have different concentrations of a protein or molecule of interest. In various embodiments, the first and second drops are larger, relative to other techniques that incorporate use of drops, discussed above. The first drops are placed in first dispensing regions of a head and the second drops are placed in second dispensing regions of a cover, which is inverted and brought into contact with the head to form nanocalorimeter cells containing sets of drops. The first and second drops within each nanocalorimeter cell may be merged using an arcing jog motion to provide merged drops, and the first and second liquids within the merged drops, respectively, may be mixed using pre-dispensed, high permeability mini-bars that spin in response to a rotating magnetic field. The rotating magnetic field may be generated by two pairs of Helmholtz coils orthogonally aligned and driven by low frequency currents in phase-quadrature.

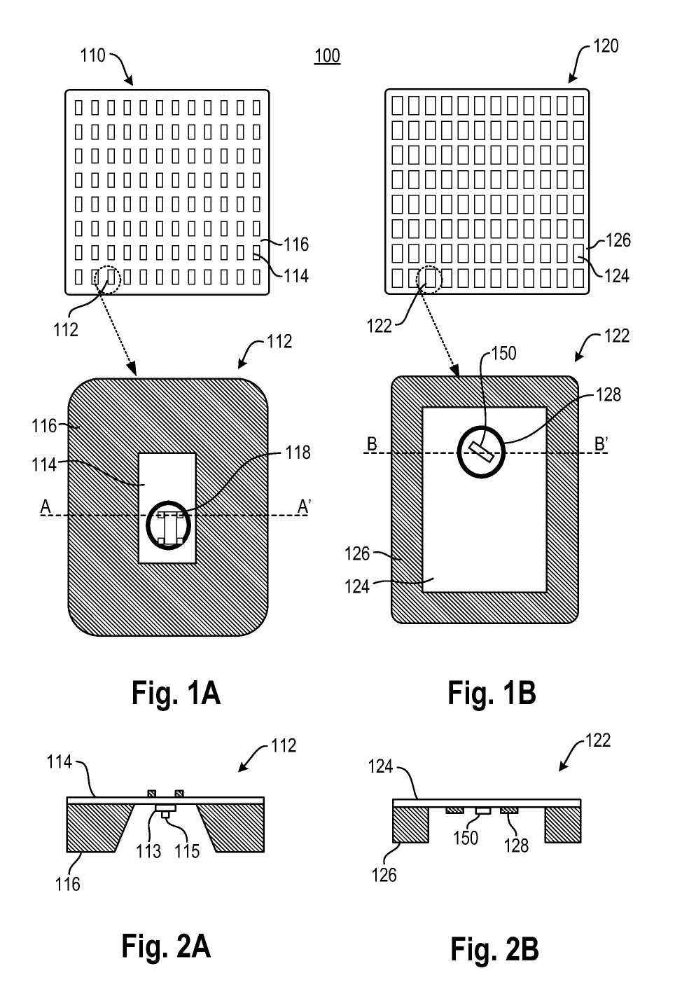

FIGS. 1A and 1B are top plan views of a nanocalorimeter device in an open state, according to a representative embodiment. FIGS. 2A and 2B are cross-sectional views of a portion of a nanocalorimeter device, according to a representative embodiment, where the cross-section shown in FIG. 2A is taken along the line A-A′ in FIG. 1A, and the cross-section shown in FIG. 2B is taken along the line B-B′ in FIG. 1B.

Referring to FIGS. 1A through 2B, nanocalorimeter device 100 includes a head 110 and a cover 120 configured to join or connect to the head 110. In particular, the cover 120 is inverted and brought into physical contact with the head 110, such that the (inverted) front side of the cover 120 faces the front side of the head 110. The connection of the cover 120 to the head 110, including inversion of the cover 120 and alignment with the head 110, may be performed automatically by a calorimeter test instrument into which the cover 120 and the head 110 are loaded.

The head 110 defines an array of first dispensing regions 112 (or first windows) that are configured to receive first drops of first liquids from a first class of liquids, respectively. In particular, the head 110 includes a membrane 114 formed on a supporting frame 116, which provides a grid pattern of rectangular spaces corresponding to the array of first dispensing regions 112. In the depicted configuration, the head 110 includes an 8×12 array of first dispensing regions 112. Each of the first dispensing regions 112 has dimensions conducive to merging first and second drops of liquid and performing calorimetric measurements, as discussed below, which may be about 4 mm by about 6 mm, for example. The membrane 114 may be formed of a suitable polyimide film, and the supporting frame 116 may be formed of a rigid polycarbonate, for example. Of course, other sizes and/or other materials may be incorporated without departing from the scope of the present teachings.

Referring to FIG. 1A, a representative one of the first dispensing regions 112 is shown in magnified form for purposes of explanation. An exposed portion of the membrane 114 is surrounded by the supporting frame 116. On a front side of the membrane 114, which is naturally hydrophilic, an annular ring pattern 118 is formed using a hydrophobic material, such as a suitable in-organic film. The ring pattern 118 forms a “corral” like structure, such that a first drop dispensed inside the ring pattern 118 is contained due to the hydrophobic material.

Referring to FIG. 2A, which likewise shows one representative first dispensing region 112, the membrane 114 is formed on the supporting frame 116, as discussed above. The ring pattern 118 is formed on a front side of the membrane 114 for containing a first drop of the first liquid dispensed in the first dispensing region 112. Gold pads 113 are affixed to a back side of the membrane 114, where the gold pads 113 may be arranged substantially parallel to one another. A quartz crystal resonator 115 is attached to the gold pads 113. The quartz crystal resonator 115 acts as a temperature sensing transduction element (thermal sensor) corresponding to that particular first dispensing region 112, arranged to sense temperature. The membrane 114 acts as a thermal path for heat to flow from the first drop to the temperature sensing quartz crystal resonator 115. Using a thin membrane at the membrane 114 reduces the thermal resistance and heat-leakage paths are kept to a minimum.

Referring to FIGS. 1B and 2B, the cover 120 similarly defines an array of second dispensing regions 122 (or second windows) that are configured to receive second drops of second liquids from a second class of liquids, respectively. In particular, the cover 120 includes a membrane 124 formed on a supporting frame 126, which provides a grid pattern of rectangular spaces corresponding to the array of second dispensing regions 122. In the depicted configuration, the cover 120 includes an 8×12 array of second dispensing regions 122 corresponding to the 8×12 array of first dispensing regions 112 in the head 110. Each of the second dispensing regions 122 has dimensions conducive to merging first and second drops of liquid and performing calorimetric measurements, as discussed below. The dimensions of the second dispensing regions 122 (e.g., about 5 mm by about 7 mm) may be larger than the dimensions of the first dispensing regions 112. This assures that the supporting frame 126 mates with the membrane 114 over the supporting frame 116, which is stiffer and thicker than the relatively fragile membrane 114, when the cover 120 is brought into contact with the head 110. Also, this provides sufficient space for the second dispensing regions 122 to contain the second drop offset from the first drop within a calorimeter cell, as discussed below. The membrane 124 may be formed of a suitable polyimide film and the supporting frame 126 may be formed of a rigid polycarbonate, for example. Of course, other sizes and/or other materials may be incorporated without departing from the scope of the present teachings.

A representative one of the second dispensing regions 122 is shown in magnified form for purposes of explanation. An exposed portion of the membrane 124 is surrounded by the supporting frame 126. On a front side of the membrane 124, which is naturally hydrophilic, an annular ring pattern 128 is formed using a hydrophobic material, such as a suitable organic film. As discussed above, the ring pattern 128 forms a “corral” like structure, such that a second drop of the second liquid dispensed inside the ring pattern 128 is contained due to the hydrophobic material.

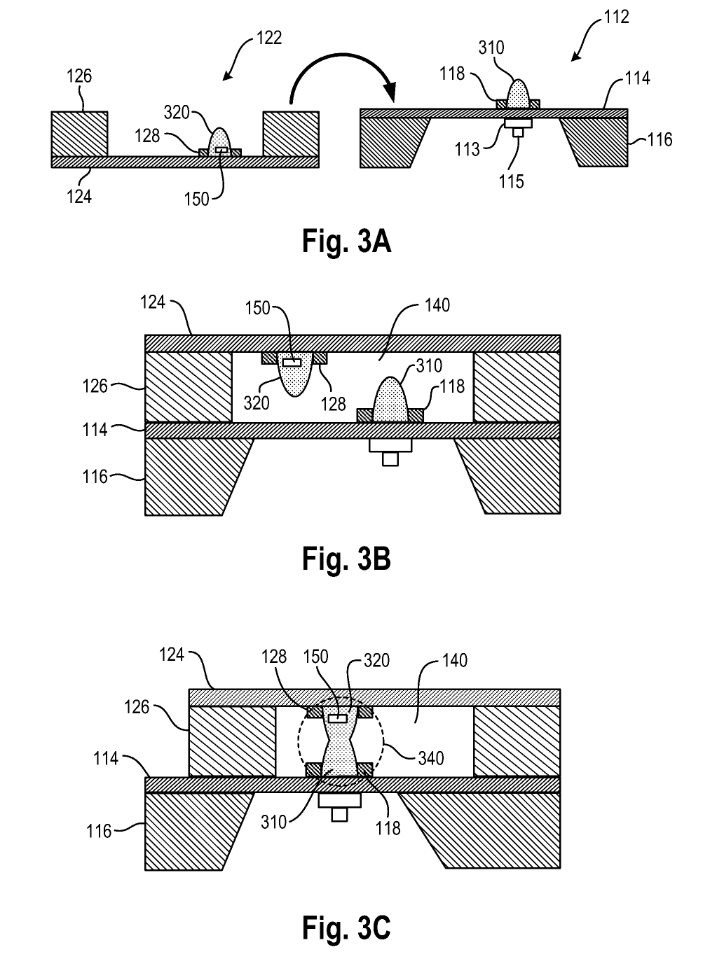

In addition, according to an embodiment, a mini-bar 150 is pre-dispensed in each of the second dispensing regions 122 of the cover 120 in order to facilitate a subsequent mixing operation. Each mini-bar 150 is formed of a high magnetic permeability material, such as Metglas®, for example, so that it is responsive to magnetic fields. Accordingly, the mini-bars 150 are present within nanocalorimeter cells (e.g., nanocalorimeter cell 140 shown in FIGS. 3B and 3C), respectively, formed once the cover 120 is connected to the head 110. Each mini-bar 150 may be coated with a layer of hydrophilic material, such as silicon dioxide (SiO₂), for example, to achieve hydrophilicity. Also, each mini-bar 150 may have dimensions of about 1 mm×about 0.2 mm×about 0.015 mm, for example. Of course, the materials and sizes of the mini-bars 150 may vary without departing from the scope of the present teachings.

More particularly, the mini-bar 150 is positioned within the ring pattern 128 of each second dispensing region 122, so that it will be contained in the second drop of the second liquid when added. Each pre-dispensed mini-bar 150 may be held in position by surface tension provided by a thin layer of water or other appropriate liquid (not shown) the cover 120. Once the mini-bars 150 have been dispensed in the second dispensing regions 122 (e.g., by the manufacturer), a moisture holding film (not shown) may be applied to the front side of the cover 120 to protect the cover 120 and to hold the mini-bars 150 and the thin layer of water in place, e.g., for cleanliness, transport or storage, until the user is ready to connect the cover 120 to the head 110. The moisture holding film may then be peeled off, just prior to the connection, to assure that every second dispensing region 122 still contains a corresponding properly positioned mini-bar 150. In an embodiment, the cover 120 with the pre-dispensed mini-bars 150 may be disposable, so that it may be discarded after performing a calorimetric measurement.

Pre-dispensing the mini-bars 150 eliminates the difficult task of the end user attempting to deposit the mini-bars 150 within the second dispensing regions 122 (or within the first dispensing regions 112) themselves. This makes overall usage of the nanocalorimeter device 100 more robust and user friendly, while reducing the chance of sample contamination or misplacement of the mini-bars 150.

FIG. 3A is a cross-sectional view of a portion of a nanocalorimeter device in an open state, according to a representative embodiment. FIGS. 3B and 3C are cross-sectional views of the portion of the nanocalorimeter device in a closed state before and after a merging operation, according to a representative embodiment.

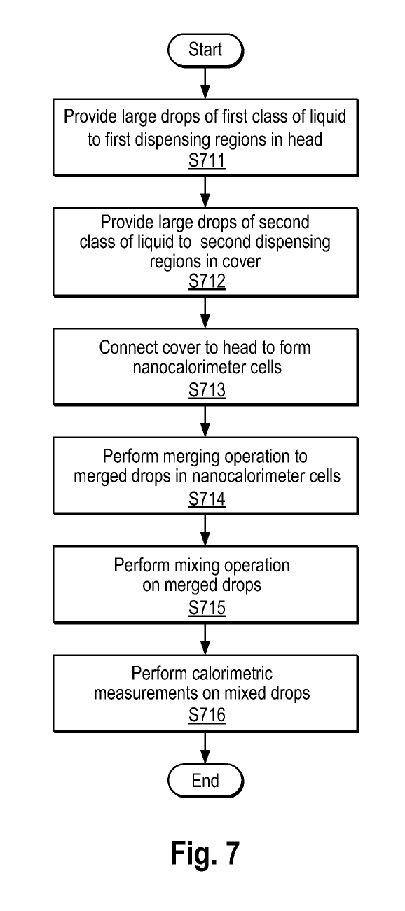

Referring to FIG. 3A, the head 110 and the cover 120 are each depicted with the front side facing upward to receive a drop of liquid. A first drop 310 of a first liquid from the first liquid class is disposed in the ring pattern 118 of the first dispensing region 112, and a second drop 320 of a second liquid from the second liquid class is disposed in the ring pattern 128 of the second dispensing region 122. In an embodiment, each of the first and second drops 310 and 320 may have relatively large volumes, e.g., in a range of about 1 μl to about 2 μl, as compared to sample volumes of other reported techniques that incorporate use of drops, as discussed below with reference to FIG. 7. The cover 120 is then connected to the head 110, meaning that the cover 120 is inverted and brought into physical contact with the head 110, as indicated by the arrow. As a result, each second dispensing region 122 substantially aligns with a corresponding first dispensing region 112 to form an enclosed nanocalorimeter cell 140, as shown in FIGS. 3B and 3C. Each of the nanocalorimeter cells 140 thereby contains a first drop 310 of first liquid contained in the corresponding one of the first dispensing regions 112 and a second drop 320 of second liquid contained in the corresponding one of the second dispensing regions 122.

In operation, once the first and second drops 310 and 320 have been suitably dispensed and the cover 120 and the head 110 are brought together, a small volume surrounds the unmerged first and second drops 310 and 320, allowing for a very small quantity of water to evaporate from the first and second drops 310 and 320, enabling relative humidity within the nanocalorimeter cell 140 to reach about 100 percent locally. When the first and second drops 310 and 320 are relatively large (e.g., in a range of about 1 μl to about 2 μl) and the enclosing volume of the nanocalorimeter cell 140 is relatively small (e.g. a few tens of microliters, such as about 50 μl to about 100 μl), and assuming the initial relative humidity is around 90 percent in the loading region, thermal equilibrium with about 100 percent relative humidity may be established relatively quickly (e.g., in about 3 minutes). Only after this thermal equilibrium is established is the merge operation initiated, while the magnetic mini-bars 150 are set in motion in preparation for the calorimetric measurements.

Initially, the first drop 310 and the second drop 320 are kept separate from each other within the respective nanocalorimeter cells 140. For example, the first drop 310 of first liquid and the second drop 320 of second liquid may be offset from one another in a substantially horizontal direction, as shown in FIG. 3B. Then, during a measurement run, the first and second drops 310 and 320 are merged into a merged drop 340, as shown in FIG. 3C, containing the first and second liquids from the first and second liquid classes, respectively, according to a merge operation, discussed below. Further, the first and second liquids from the first and second drops 310 and 320 are mixed within the merged drop 340 according to a mixing operation, involving magnetic stimulation of the mini-bar 150, also discussed below. The merging operation may be completed before the mixing operation begins, or all or a portion of the mixing operation may occur while the merging operation is being performed. In addition, the quartz crystal resonator 115 is arranged to sense the temperature in the nanocalorimeter cell 140. In various embodiments, there may also be heating and/or cooling elements (not shown) configured to maintain ambient air and components inside an enclosed volume, surrounding the head 110 and cover 120, at a pre-determined temperature. Profiles of the sensed temperatures from the multiple nanocalorimeter cells 140 may be used to determine enthalpy of reactions within the nanocalorimeter cells 140 caused by mixing the first and second liquids within the merged drops 340.

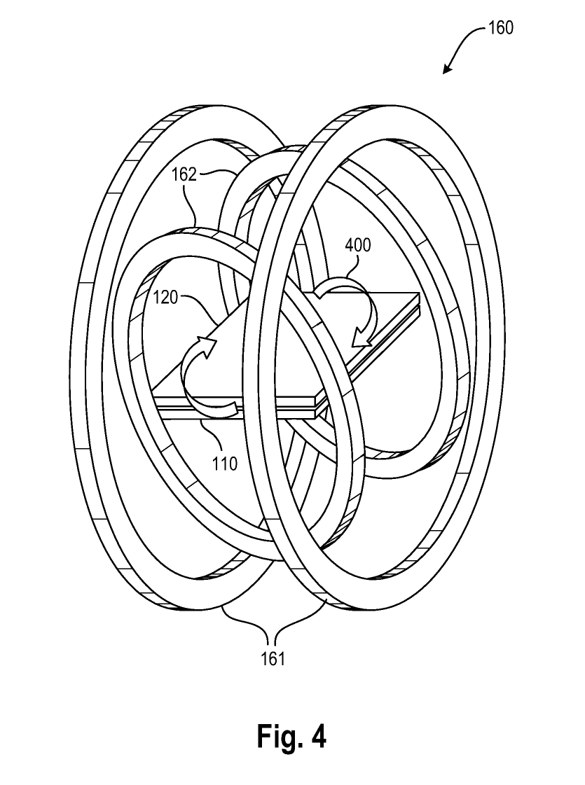

Referring to FIG. 4, the calorimetric device 100 further includes a magnetic driver 160 that is configured to generate a rotating magnetic field 400 around the assembled head 110 and the cover 120. The rotating magnetic field 400 causes the mini-bars 150 to spin within the merged drops 340, thereby mixing the first and second liquids in the merged drop 340 within each nanocalorimeter cell 140. This mechanical mixing within each merged drop 340 greatly reduces mixing time to achieve a homogenous state. Because the rotating magnetic field 400 encompasses all of the nanocalorimeter cells 140, the spinning mini-bars 150 are able to stir all the merged drops 340 substantially simultaneously (in parallel).

In the depicted embodiment, the magnetic driver 160 includes first and second Helmholtz coil pairs 161 and 162 surrounding the connected head 110 and cover 120. The first and second Helmholtz coil pairs 161 and 162 are orthogonally aligned with a plane containing the front side surface of the head 110, for example. The first and second Helmholtz coil pairs 161 and 162 are electrically activated to generate the rotating magnetic field 400, causing the mini-bars 150 to spin.

In various embodiments, the first and second Helmholtz coil pairs 161 and 162 are driven by low frequency AC currents in phase-quadrature, for example. The low frequency AC current may be in a range of less than about 10 Hertz, for example. The AC currents may be electrically activated and deactivated to selectively control application of the magnetic field 400. For example, deactivating the AC currents prior to the merging and mixing operations (e.g., during set up) prevents the presence of a magnetic field from inadvertently dislodging the mini-bars 150 from their optimal positions within the second dispensing regions 122. The AC currents may then be activated to create the rotating magnetic field 400 once the cover 120 and the head 110 have been joined, and the mixing operation is desired. The process therefore avoids the presence of static magnetic fields that can dislodge the mini-bars 150, as mentioned above. In comparison, other reported techniques using spinning bar magnets require delicate procedures for bringing the bar magnets into place, since the presence of static magnetic fields (or prematurely applied rotating magnetic fields) may dislodge the mini-bars, leading to inefficient and possibly even no mixing.

Use of the mini-bars 150 activated by the Helmholtz coil pairs 161 and 162 reduces mixing time to more quickly provide a homogenized state for the merged drop. This improves the signal to noise ratio (SNR) of the measurement, for example. Also, use of the mini-bars 150 eliminates the need to vibrate one or both of the head 110 and the cover 120, for example, as suggested in other reported mixing techniques.

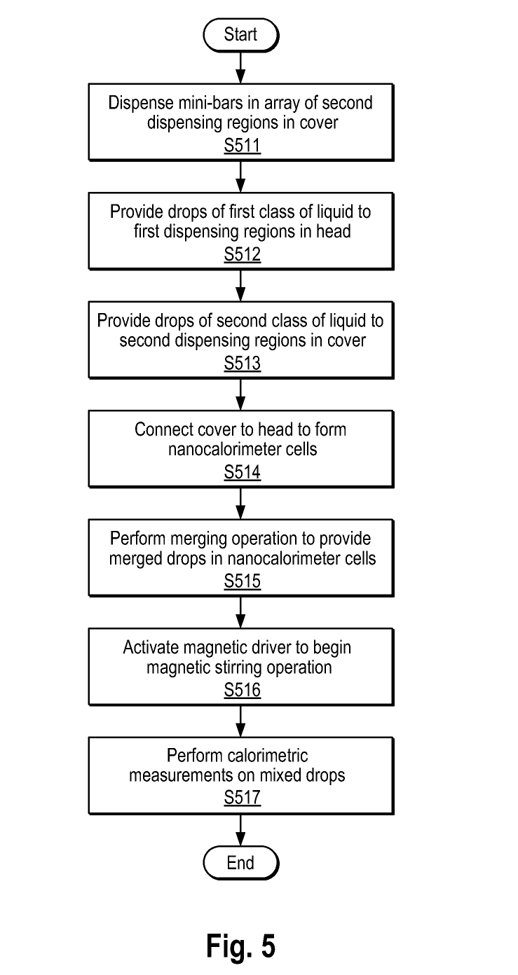

FIG. 5 is a flow diagram showing a method of mixing liquids within merged drops of nanocalorimeter cells of a nanocalorimeter device, according to a representative embodiment.

Referring to FIG. 5, mini-bars are dispensed in an array of second dispensing regions defined by a cover of a nanocalorimeter device in block S511. The mini-bars may be held in place by surface tension provided by a thin layer of water or other appropriate liquid. The surface of the cover may then be covered by a removable protective film that maintains cleanliness and provides protection during transport or storage.

The cover containing the mini-bars is loaded into an instrument containing a head of the nanocalorimeter device in order to perform calorimetric measurements. First drops of first liquid from a first class of liquids are provided to corresponding first dispensing regions in the head of a nanocalorimeter device in block S512, and second drops of second liquid from a second class of liquids are provided to corresponding second dispensing regions in the cover of the nanocalorimeter device in block S513. The nanocalorimeter device is in an open state at the time the first and second drops are added.

In block S514, the cover is connected to the head of the nanocalorimeter device, such that the first dispensing regions and the second dispensing regions combine to form corresponding nanocalorimeter cells, respectively. That is, the cover is inverted, and the (inverted) top surface of the cover and the top surface of the head are brought into physical contact with one another. Accordingly, each nanocalorimeter cell contains a first drop of first liquid and a second drop of second liquid, which are initially laterally offset from one another. The first and second drops may have relatively large volumes, e.g., in a range of about 1 μl to about 2 μl, as compared to sample volumes in other reported techniques that incorporate use of drops, as discussed below with reference to FIG. 7.

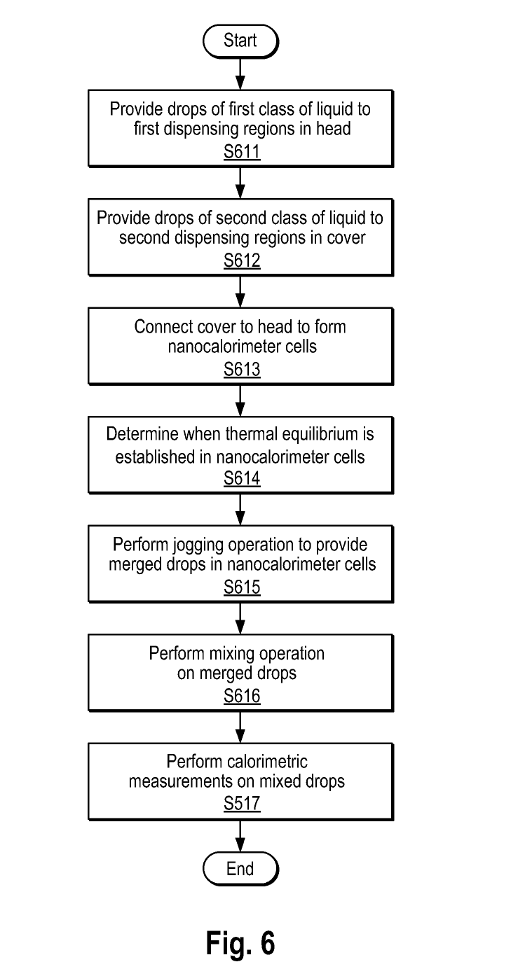

In block 5515, a merging operation is performed in order to merge the first and second drops into a merged drop, containing the corresponding first and second liquids, within each nanocalorimeter cell. The merging operation may be performed by separating and quickly reconnecting the cover to the head in an arcing jog motion, as discussed below with reference to FIG. 6.

Once the first and second drops have merged (or while the first and second drops are merging), a magnetic driver is activated in block 5516 to begin a magnetic stirring operation to mix the first and second liquid in the merged drop. The magnetic driver may include two pairs of orthogonally aligned, stationary Helmholtz coils, for example, as shown in FIG. 4. More particularly, activating the magnetic driver generates a spatially uniform rotating magnetic field around the nanocalorimeter cells, which cause the mini-bars dispensed within the second distribution regions in operation 5511 to spin within the merged drops, thereby mixing the respective first and second liquids in the merged drop. Calorimetric measurements are performed on the merged/mixed drops in block 5517 during and/or following the magnetic stirring operation in block 5516 utilizing thermal sensors in the head 110, e.g., the quartz crystal resonators 115. Ambient temperature of the environment surrounding the head 110 and the cover 120 may be controlled and kept constant before and during the measurement for optimum accuracy. Measurements may be performed at different ambient temperatures.

According to various embodiments, a method of performing measurements using a nanocalorimeter device 100 includes efficiently merging drops within nanocalorimeter cells 140. The method includes having first and second drops 310 and 320 of first and second liquids, respectively, enclosed in the small volume of the nanocalorimeter cell 140, but laterally offset as shown in FIG. 3B, while waiting for thermal equilibrium to be established. Generally, thermal equilibrium is established when the relative humidity reaches about 100 percent as indicated by a temperature, stabilized to a set point of the nanocalorimeter cell 140. Once thermal equilibrium is achieved, the cover 120 is separated from and quickly reconnected to the head in an arcing jog motion to merge the first and second drops 310 and 320, as shown in FIG. 3C, while maintaining the approximately 100 percent humidity, as discussed below. The method takes place in the context of a simplified design of the head 110 that reduces heat leakage pathways, as discussed above, which negatively affect conventional merging schemes.

FIG. 6 is a flow diagram showing a method of merging drops within nanocalorimeter cells of a nanocalorimeter device, according to a representative embodiment.

Referring to FIG. 6, first drops of first liquid from a first class of liquids are provided to corresponding first dispensing regions in a head of a nanocalorimeter device in block S611, and second drops of second liquid from a second class of liquids are provided to corresponding second dispensing regions in a cover of the nanocalorimeter device in block S612. The nanocalorimeter device is in an open state at the time the first and second drops are added.

In block S613, the cover is connected to the head of the nanocalorimeter device, such that the first dispensing regions and the second dispensing regions combine to form corresponding nanocalorimeter cells, respectively. Accordingly, each nanocalorimeter cell contains a first drop of first liquid and a second drop of second liquid, which are initially laterally offset from one another. The first and second drops may have relatively large volumes, e.g., in a range of about 1 μl to about 2 μl, as compared to sample volumes of other reported techniques that incorporate use of drops, as discussed below with reference to FIG. 7. In this case, each of the nanocalorimeter cells may have a volume of about 50 μl to about 100 μl, for example. This provides sufficient space to accommodate the first and second drops without actually merging (remaining laterally offset, as mentioned above) before the merging operation.

The relatively small volume of the nanocalorimeter cells enables thermal equilibrium to be quickly established, with a relative humidity of about 100 percent, with minimal evaporation of the first and second drops of the first and second liquids. For example, in a nanocalorimeter cell having a volume of about 50 μl to about 100 μl, thermal equilibrium may be established quickly (e.g., in about 3 minutes), depending on various factors such as the types of first and second liquid classes and the ambient temperature of the surrounding environment. It is determined in block S614 when thermal equilibrium has been established within the nanocalorimeter cells (e.g., when relative humidity reaches about 100 percent). Monitoring may be performed using the quartz resonator thermometer element attached to the backside of the (Si-nitride) membrane that forms the top surface of the head of the nanocalorimeter device, discussed above to determine when the block s614 has come to thermal equilibrium.

Once it has been determined that thermal equilibrium is established, a jogging operation is performed in block 5615. The jogging operation consists of separating the cover from the head, and quickly reconnecting the cover to the head while performing an arcing movement. The whole operation must be performed quickly (˜seconds), and with as little displacement and air turbulence as possible. For example, performing the jogging operation quickly means that when the cover is reconnected to the head, sealing each individual cell of the array again, the previously established thermal equilibrium in each cell volume is substantially unchanged (e.g., less than about 1 second). The arcing movement refers to moving the cover vertically only enough to clear the head surface, then moving the cover laterally in an amount sufficient to align locations of the first and second drops, and then vertically again to bring the cover back into contact with the head to seal off the array of cells. The lateral movement causes a shifting motion of the second drop of second liquid so that it is positioned to contact the first drop of first liquid when the cover is reconnected and the corresponding nanocalorimeter cell is reformed. This causes the first and second drops within each nanocalorimeter cell to contact and coalesce into a merged drop containing the corresponding first and second liquid, and held in place by surface wetting forces. The implementation is simple and significantly reduces thermal leakage paths.

Once the first and second drops have merged (or while the first and second drops are merging), a mixing operation is performed in block 5616 in order to mix the first and second liquids within each of the merged drops. The mixing operation may include a magnetic stirring operation using previously positioned mini-bars driven by a spatially uniform rotating magnetic field, as discussed above with reference to FIG. 4. Calorimetric measurements are performed on the merged/mixed drops in block 5617.

According to various embodiments, a method of performing measurements using a nanocalorimeter device includes providing first drops 310 of first liquid from the first class of liquids, each of which has a volume in a range of about 1 microliter (μl) to about 2 μl, in the first dispensing regions 112, and second drops 320 of second liquid from the second class of liquids, each of which also has a volume in the range of about 1 μl to about 2 μl, in the second dispensing regions 122, for example. In comparison, other reported techniques that use drops of samples to perform measurements using a nanocalorimeter require that the drops be in the range of hundreds of nanoliters, and in particular about 250 nl, for example.

Employing the larger first and second drops 310, 320 (e.g., about 1 μl to about 2 μl) generally reduces inaccuracies in dispensing of the first and second liquids, thereby eliminating the need to carry out separate in-situ measurements to determine drop sizes. The use of larger first and second drops 310, 320 generally requires more material than other reported small volume drops, although the time savings and reduced complexity of performing the measurements improve overall accuracy of the measurement and increases efficiency. Also, the coefficient of variance (of the dispensed drop size) is generally smaller as the drop size increases for a given syringe or other dispensing scheme. In other words, on average, larger first and second drops 310, 320 are more accurate than smaller drops. In embodiments, the first and second drops 310, 320 may be larger than about 2 μl.

This in turn enables a simpler and more robust design of the head 110, with fewer components, which minimizes thermal leakage paths and eliminates the need for in-situ heaters and heat spreading copper and/or gold pads to measure drop volume, as used in the other reported systems, which would otherwise lead to larger thermal masses, and reduction in signal strength and SNR performance. The simplified head 110 also reduces manufacturing costs. Also, the thermal mass associated with the signal measuring region is reduced, which in turn leads to larger signals, faster response times, and improved SNR.

On the other hand, as compared to conventional ITC techniques that use liquid samples in amounts larger than what can be characterized as drops, first and second drops 310 and 320 having volumes in the range of about 1 μl to about 2 μl contain a relatively small amount of material (e.g., molecules and/or proteins). For example, a first drop 310 (or second drop 320) having a volume of about 1 μl contains about 30 μg of material, while a typical liquid sample of a conventional ITC technique contains at least 120 μg, which is at least four times more material. Indeed, depending on the specific instrument, a liquid sample of a conventional ITC technique may contain up to about 26 times more material than a first drop 310 (or second drop 320) having a volume of about 1 μl, for example.

FIG. 7 is a flow diagram showing a method of performing measurements within nanocalorimeter cells of a nanocalorimeter device using large drops (e.g., about 1 μl to about 2 μl in volume), according to a representative embodiment.

Referring to FIG. 7, large first drops of first liquid from a first class of liquids are provided to corresponding first dispensing regions in a head of a nanocalorimeter device in block S711, and large second drops of second liquid from a second class of liquids are provided to corresponding second dispensing regions in a cover of the nanocalorimeter device in block S712. The nanocalorimeter device is in an open state at the time the large first and second drops are added. Each of the large first and second drops of first and second liquids has a volume in a range of about 1 μl to about 2 μl, as mentioned above. Generally, the large first drops may be about equal in volume to one another, and the large second drops may be about equal in volume to one another. Further, the large first drops may be equal in volume to the large second drops. However, the large first drops may have different volumes, the large second drops may have different volumes, and/or the large first and second drops may have different volumes from one another, without departing from the scope of the present teachings.

In block S713, the cover is connected to the head of the nanocalorimeter device, such that the first dispensing regions and the second dispensing regions combine to form corresponding nanocalorimeter cells, respectively. Accordingly, each nanocalorimeter cell contains a first drop of first liquid and a second drop of second liquid, which may be initially laterally offset from one another. Each of the nanocalorimeter cells would have a volume of about 50 μl to about 100 μl, for example, to provide sufficient space for the first and second large drops in each nanocalorimeter cell without actually merging initially (e.g., before the merging operation).

In block S714, a merging operation is performed in order to merge the first and second drops of first and second liquids into a merged drop within each nanocalorimeter cell. The merging operation may be performed by separating and quickly reconnecting the cover to the head in an arcing jog motion, as discussed above with reference to FIG. 6. Notably, due to the relatively large volumes of the first and second drops, thermal equilibrium is reached within the nanocalorimeter cells relatively quickly (approximately 3 minutes).

Once the first and second drops have merged (or while the first and second drops are merging), a magnetic stirring operation may be performed in block S715 in order to mix the corresponding first and second liquids within each of the merged drops. The magnetic stirring operation may be performed using previously positioned mini-bars driven by a spatially uniform rotating magnetic field, as discussed above with reference to FIG. 5. Calorimetric measurements are performed on the merged/mixed drops in block S716.

In other reported nanocalorimeters, the head is carefully designed to achieve adequate SNR, for measuring enthalpy of reactions taking place in the small drops. For the measurement to be accurate, the concentrations of the two drops and their respective thermal masses must be known. Molecular concentrations are established prior to dispensing, while the thermal mass depends on the volume dispensed. With small drops (e.g. in the hundreds of nanoliters to achieve minimal protein consumption), as suggested in other reported schemes, the volume and mass must be measured with great accuracy, and mass loss due to evaporation may become significant prior to the drop merging step. Uncertainty in drop volume leads to uncertainty in the calculated heat generated and/or absorbed, and ultimately leads to poor numbers for the thermodynamic quantities of interest, such as enthalpy (AH), dissociation equilibrium constant (Kd), and specific heat (Cp).

In comparison, according to an embodiment, the large first and second drops of first and second liquids have less evaporation. That is, the large first and second drops have much less exposed surface area with respect to drop volume, so they will lose a smaller percentage of their mass through evaporation for a given temperature and relative humidity. Also, as mentioned above, dispensing accuracy is improved with the larger drops. The large first and second drops of first and second liquids thereby reduce inaccuracies associated with conventional small drop (e.g., about 250 nl).

While the disclosure references illustrative embodiments, it will be apparent to those skilled in the art that various changes and modifications may be made without departing from the spirit and scope of the present teachings. Therefore, it should be understood that the above embodiments are not limiting, but illustrative.

What is claimed is:

1. A nanocalorimeter device, comprising:
a head defining a plurality of first dispensing regions configured to receive a plurality of first drops of first liquids from a first class of liquids, respectively;
a cover defining a plurality of second dispensing regions corresponding to the plurality of first dispensing regions and configured to receive a plurality of second drops of second liquids from a second class of liquids, respectively, wherein the plurality of first dispensing regions and the plurality of second dispensing regions form a corresponding plurality of nanocalorimeter cells when the cover is connected to the head, each nanocalorimeter cell thereby containing a first drop of the plurality of first drops and a second drop of the plurality of second drops which are combined during a measurement run into a merged drop containing the corresponding first and second liquids;
a plurality of mini-bars pre-dispensed in the plurality of second dispensing regions, respectively, each mini-bar comprising a high magnetic permeability material; and
a magnetic driver configured to generate a rotating magnetic field around the plurality of nanocalorimeter cells, wherein the rotating magnetic field causes the plurality of mini-bars to spin, mixing the first and second liquids in the merged drop within each nanocalorimeter cell.

2. The nanocalorimeter device of claim 1, wherein the magnetic driver comprises two pairs of orthogonally placed Helmholtz coils.

3. The nanocalorimeter device of claim 2, wherein the Helmholtz coils are electrically activated to generate the rotating magnetic field, enabling the mixing of the first and second liquids in the merged drop.

4. The nanocalorimeter device of claim 1, wherein each mini-bar is coated with a layer of hydrophilic material to achieve hydrophilicity.

5. The nanocalorimeter device of claim 1, wherein each mini-bar is held in place by surface tension provided by a thin layer of liquid.

6. The nanocalorimeter device of claim 1, wherein each of the first and second drops has a volume greater than about 1 μl.

7. The nanocalorimeter device of claim 1, wherein each of the first and second drops has a volume greater than about 2 μl.

8. The nanocalorimeter device of claim 1, wherein the cover is separated from and quickly reconnected to the head in an arcing movement, causing the first and second drops within each nanocalorimeter cell to contact and coalesce into the merged drop, the second drop initially being laterally offset from the first drop within each nanocalorimeter cell.

9. The nanocalorimeter device of claim 8, wherein the cover is separated from and quickly reconnected to the head after thermal equilibrium is established within each nanocalorimeter cell.

10. The nanocalorimeter device of claim 1, further comprising:
a plurality of thermal sensors arranged to sense temperatures in the plurality of nanocalorimeter cells, respectively.

11. The nanocalorimeter device of claim 10, wherein profiles of the sensed temperatures with respect to time are used to determine enthalpy of reactions within the nanocalorimeter cells caused by mixing the first and second liquids in the merged drop.

12. A method of performing measurements using a nanocalorimeter device, the method comprising:
providing a plurality of first drops of first liquids from a first class of liquids to a corresponding plurality of first dispensing regions in a head of the nanocalorimeter device;
providing a plurality of second drops of second liquids from a second class of liquids to a corresponding plurality of second dispensing regions in a cover of the nanocalorimeter device;
connecting the cover to the head, such that the plurality of first dispensing regions and the plurality of second dispensing regions combine to form a corresponding plurality of nanocalorimeter cells, each nanocalorimeter cell containing a first drop of the plurality of first drops and a second drop of the plurality of second drops laterally offset from the first drop; and
separating the cover from the head and quickly reconnecting the cover to the head in an arcing movement, causing the first and second drops within each nanocalorimeter cell to contact and coalesce into a merged drop containing the first and second liquids.

13. The method of claim 12, further comprising:
determining when relative humidity reaches about 100 percent within each nanocalorimeter cell, wherein the cover is separated from and quickly reconnected to the head in the arcing movement after the relative humidity is determined to have reached about 100 percent.

14. The method of claim 12, further comprising:
determining when thermal equilibrium is established within each nanocalorimeter cell, wherein the cover is separated from and quickly reconnected to the head in the arcing movement after the thermal equilibrium is established.

15. The method of claim 12, wherein each of the first and second drops has a volume in a range of about 1 μl to about 2 μl.

16. The method of claim 12, further comprising:
applying a rotating magnetic field around the plurality of nanocalorimeter cells for mixing the first and second liquids in the merged drop within each nanocalorimeter cell.

17. The method of claim 16, further comprising:
pre-dispensing a plurality of mini-bars in the plurality of second dispensing regions, respectively, before providing the plurality of second drops class to the plurality of second dispensing regions, each mini-bar comprising a high magnetic permeability material,
wherein application of the rotating magnetic field causes the plurality of mini-bars to spin, mixing the first and second liquids in the merged drop within each nanocalorimeter cell.

18. The method of claim 17, wherein each mini-bar is coated with a layer of hydrophilic material to achieve hydrophilicity.

19. A method of performing measurements using a nanocalorimeter device, the method comprising:
providing a plurality of first drops of first liquids in a first class of liquids to a corresponding plurality of first dispensing regions in a head of the nanocalorimeter device, each first drop having a volume in a range of about 1 μl to about 2 μl;
providing a plurality of second drops of second liquids in a second class of liquids to a corresponding plurality of second dispensing regions in a cover of the nanocalorimeter device, each second drop having a volume in a range of about 1 μl to about 2 μl;
connecting the cover to the head, such that the plurality of first dispensing regions and the plurality of second dispensing regions combine to form a corresponding plurality of nanocalorimeter cells, each nanocalorimeter cell containing a first drop of the plurality of first drops and a second drop of the plurality of second drops laterally offset from the first drop;
merging the first and second drops into a merged drop comprising the first and second liquids, respectively, within each nanocalorimeter cell; and
mixing the first and second liquids in the merged drop.

20. The method of claim 19, wherein merging the first and second drops into the merged drop comprises separating the cover from the head and quickly reconnecting the cover to the head in an arcing movement, causing the first and second drops within each nanocalorimeter cell to contact and coalesce into the merged drop comprising the first and second liquids.
